(19) United States
(12) Patent Application Publication
(10) Pub. No.: US 2005/0180441 A1
(43) Pub. Date: Aug. 18, 2005

(54) Soft permanent virtual circuit (PVC) network management

(76) Inventor: Yong-Sik Im, Seoul (KR)

Correspondence Address: Robert E. Bushnell;Suite 300, 1522 K Street, N.W., Washington, DC, 20005-1202, US

(21) Appl. No.: 11/033,505

(22) Filed: Jan. 12, 2005

(30) Foreign Application Priority Data
Feb. 18, 2004 (KR) 2004-10816

(51) Int. Cl. H04L 12/56

(52) U.S. Cl. 370/409

(57) ABSTRACT

A network management system for a soft Permanent Virtual Circuit (PVC) and a corresponding method include: a plurality of managed systems; an upper manager adapted to fetch information for Managed Objects (MOs) from the plurality of managed systems and to issue an instruction to the MOs; and a workstation, including respective agents connected to the plurality of managed systems in a one-to-one manner, adapted to deliver the instruction from the upper manager to the plurality of managed systems on behalf of the upper manager and to deliver the MO information from the plurality of managed systems to the upper manager, the workstation managing the respective agents in an integrated manner.

### CLAIM OF PRIORITY

This application makes reference to, incorporates the same herein, and claims all benefits accruing under 35 U.S.C. §119 from an application for NETWORK MANAGEMENT SYSTEM FOR SOFT PERMANENT VIRTUAL CIRCUIT AND METHOD THEREOF earlier filed in the Korean Intellectual Property Office on 18 Feb. 2004 and there duly assigned Serial No. 2004-10816.

### BACKGROUND OF THE INVENTION

1. Field of the Invention

The present invention relates to soft Permanent Virtual Circuit (PVC) network management via a Common Management Information Protocol (CMIP) agent.

2. Description of the Related Art

Present Network Management Systems (NMSs) have a structure in which, through a representative called an intermediate agent, an upper manager fetches information for resources from a managed system, issues an instruction to the managed system if necessary, and receives various messages from the managed system. To perform these functions, the agent must shape and manage physical/logical information, such as the configuration, failure, connection, statistics, Operational Asset Management (OAM) and the like of the system, into a concept of a Managed Object (MO). A circuit connection method, includes a Permanent Virtual Channel (PVC) method, a Frame Relay (FR) method, a soft Permanent Virtual Channel (PVC) connection method, and the like.

A conventional PVC connection scheme has resources (e.g., port, VPI and VCI) of a predetermined port that are permanent. The scheme has a problem in that movement to another route upon an occurrence of a failure is impossible, thereby resulting in a service interruption. Furthermore, with the convention PVC connection scheme, it is difficult to efficiently distribute and share a connection resource due to the manner of occupying determined resources, thereby imposing a high service charge.

On the other hand, the soft PVC connection scheme has a structure in which a path between intermediate switch nodes is composed of a Switched Virtual Connection (SVC), wherein a communication path is established or released whenever communication is effected. Because the SVC selects an arbitrary correspondent to communicate with the correspondent, it is primarily used when there are many correspondent users to communicate with or when overhead due to establishing or releasing a communication path does not matter. As a result, with the soft PVC scheme, it is possible to improve the efficiency of a resource and the continuity of a service and to reduce a financial burden in using a service in comparison with the conventional PVC scheme because the soft PVC scheme has a structure capable of automatically switching a path to an available path and maintaining a service when a failure occurs in a system or line.

To apply a soft PVC service to Network Management Software (NMS) that is commercially available at this time, a Telecommunications Management Network (TMN) service is needed. Although an agent for the PVC or FR service has been already implemented and used, an agent for the soft PVC service is needed.

Particularly, in order to implement the agent of the soft PVC service, there is a need for a variety of protocols (CMIP, CORBA, SNMP and the like) for data transmission between the upper manager and the agent. The present invention relates to implementing an agent for the CMIP protocol.

In comparison with an existing PVC, a conventional method for implementing an agent to manage a soft PVC has no significant difference in the number of MOs that must be managed by the agent, is limited to connection-creating and deleting functions, and requires more instruction-performing steps, which the agent needs to perform these functions, than those needed for a PVC connection with a manager (see, for example, Korean Patent Application No. 10-2000-0079049, filed in the Korean Intellectual Property Office on Dec. 20, 2000 and published on Jun. 26, 2002 as Korean Patent Publication No.10-2002-0049766A).

In addition, the following patents each discloses features in common with the present invention but do not teach or suggest the inventive features specifically recited in the present claims: U.S. patent application Ser. No. 2004/0085968 to Chen et al., entitled PEER TO PEER SVC-BASED DSL SERVICE, published on May 6, 2004; U.S. patent application Ser. No. 2004/0085969 to Chen et al., entitled CLIENT SERVER SVC-BASED DSL SERVICE, published on May 6, 2004; U.S. Pat. No.6,195,364 to Brodigan, entitled to VSDL MULTIPLE SERVICE PROVIDER INTERFACE, issued on Feb. 27, 2001; and U.S. patent application Ser. No. 2004/0114580 to Santry et al., entitled DYNAMIC SOFT PERMANENT VIRTUAL CIRCUIT BULK CONNECTION TRACING, published on Jun. 17, 2004.

### SUMMARY OF THE INVENTION

The present invention is conceived to solve the aforementioned problems, and it is an object of the present invention to reduce the number of soft PVC MOs by a CMIP agent by simply shaping the MOs according to a General Definition of Managed Objects (GDMO) standard.

Furthermore, it is another object of the present invention to enhance a function of an agent and reduce an operating burden on a manager by providing general instruction performance for a soft PVC connection function requested by an existing manager via a CMIP agent.

According to the present invention for achieving the above-stated objects, a network management system for a soft Permanent Virtual Circuit(PVC) is provided, the system comprising: a plurality of managed systems; an upper manager adapted to fetch information for Managed Objects (MOs) from the plurality of managed systems and to issue an instruction to the MOs; and a workstation, including respective agents connected to the plurality of managed systems in a one-to-one manner, adapted to deliver the instruction from the upper manager to the plurality of managed systems on behalf of the upper manager and to deliver the MO information from the plurality of managed systems to the upper manager, the workstation managing the respective agents in an integrated in a manner distinguishable from the prior art

A protocol between the upper manager and the agent preferably comprises a Common Management Information Protocol (CMIP).

The agents are configured separately from the plurality of managed systems and are incorporated into the workstation managing the respective agents in the integrated in a manner distinguishable from the prior art

The agents are adapted to perform processing on a Common Management Information Protocol (CMIP) related instruction issued from the manager, to deliver the instruction to a network management proxy in the plurality of managed systems, and to reflect the instruction processing result and state from the plurality of managed systems to the MO to report to the upper manager.

An object managed by an agent comprises: configuration management including at least one of shape addition and deletion, port resource allocation, modification and deletion, SVC and PVC range setup, modification and release, and subscriber information creation, modification and deletion; failure management and state management including at least one of rack, shelf, slot, board, link, fan, filter, node, and connection; performance management including atm Traffic Load and upcNpc for a relevant port or connection point upon a soft PVC connection; and connection management including at least one of soft PVC connection creation and deletion, connection re-setup including at least one of automatic re-setup and connection based retrial and block based collective resume, and path retrieval.

The MOs for building a Managing Information Base (MIB) for the objects managed by the agent comprise: a standard MO shaped into at least one of a managed Element MO (Managed Object) regarding an ATM switch, a uni MO regarding a subscriber UNI port, a tcAdptorTTPBidirectional MO regarding a port, an intraNNI MO regarding a relaying NNI port, an atmAccessProfile MO regarding port's logical information (bandwidth, VPI value, VCI value, and the like), an atmFabric MO for issuing a logical connection setup instruction, a vpCTPBidirectional MO regarding VP connection end point through which a connection end point upon VP connection or VC upon VC connection will pass, a vcCTPBidirectional MO regarding the connection end point upon the VC connection, and a vpTTPBidirectional MO regarding the VP connection end point through which the VC will pass upon the VC connection; a modification MO shaped into at least one of an MO regarding managedElement created based on a node prefix (having added prefix related office code and trunk code) of a switch for a soft PVC connection, an MO regarding uni modified to include information on a subscriber address (sn: subscriber number), an MO regarding atmAccessProfile in which PVC/SVC resources in existing standard information are modified to differentiate PVC/SVC resources from each other, and an MO regarding an atmFabric that is modified by selecting a representative MO for executing a soft PVC connection related instruction separately from the PVC connection and by adding a soft PVC related M-ACTION; and a new MO shaped into at least one of an MO regarding SoftPvcController for adding information for a called-side subscriber address, a called-side VPI/VCI connection retry number, and the like to allow a calling side to manage called-side information.

The agent builds the MIB by shaping a needed MO with a Common Management Information Service Element (CMISE).

According to the present invention for achieving the above-stated objects, a network management method for a soft Permanent Virtual Circuit (PVC) is also provided, the method comprising: building a Managing Information Base (MIB) by shaping Managed Objects (MOs) for soft PVC network management according to an MO standard; performing an initialization operation on an agent through the shaped MIB; distributing port resources and setting up subscriber information to establish the soft PVC connection after the agent initialization; creating MOs for connection points to obtain information from a managed system and to deliver an instruction; and selecting and performing at least one of connection path inquiry, failure management, performance management, connection re-setup, and an operation for unnecessary MOs according to an operator's need with respect to the MOs created by the connection creating step.

Shaping the MO information in building the MIB comprises: defining standard MOs including at least one of an ATM switch MO, a subscriber UNI port MO, a port MO, a relaying NNI port MO, a port's logical information MO, a logical connection setup instruction MO, a VP connection end point or VC-passing VP connection end point MO, a VC connection end point MO, and a VC-passing VP connection end point MO upon VC connection as a reference; modifying and using the ATM switch MO, the subscriber UNI port MO, the port's logical information MO, and the logical connection setup instruction MO that can be modified from among the standard MOs; and newly creating a SoftPvcController MO for adding information for at least one of a called-side subscriber address, and a called-side VPI/VCI connection retry number to allow a calling side to manage called-side information.

Performing initialization upon initially operating the agent comprises: invoking, by the agent, an initialization instruction function to deliver the invoked function to a network management proxy in the managed system; retrieving, by the network management proxy, a system database to query initialization information; acquiring initialization information by the agent; creating, by the network management proxy, an initialization file according to a predetermined format using the acquired data; transmitting the initialization file to the agent by the network management proxy; and shaping, by the agent, contents of the initialization file, delivered after performing the initialization routine, into the managed object to build the MIB.

The initialization file created by the network management proxy comprises: a prefix (ATM switch address information) initialization configuration parameter; a svc_range (SVC range information) initialization configuration parameter; a sn (subscriber number) initialization configuration parameter; and a spvc_conn (SPVC connection information) initialization configuration parameter.

The network management method further comprises transmitting the relevant information to the manager by the agent in response to an information request from the manager.

Setting up the subscriber information comprises: setting up a profile for a subscriber port to distribute the respective PVC and SVC resources and set up information; creating, by the agent receiving an instruction to create a link type from the manager, an MO to report the result to the manager when the link type is the same as the link type of the system obtained via the network management proxy; and reporting, by the agent receiving an instruction to create a subscriber number from the manager, a subscriber number obtained via the network management proxy to the manager.

Setting up the profile for the subscriber port comprises: receiving, by the agent, an instruction to create port's logical information from the manager; delivering, by the agent, a request signal to create port profile information to the network management proxy; delivering a relevant instruction to the managed system by the network management proxy; receiving an instruction performance result from the managed system; delivering to the agent, by the network management proxy, the result to which the relevant port information has been reflected; shaping, by the agent, the port's logical information into the managed object based on data received from the network management proxy to build the MIB; and reporting the result to the manager.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings, in which like reference symbols indicate the same or similar components, wherein:

FIG. 1 is an overall network configuration diagram for explaining a role of an agent managing a soft PVC according to an embodiment of the present invention;

FIG. 2 is a diagram of a GDMO configuration for a PVC connection;

FIG. 3 is a diagram of a GDMO configuration for a soft PVC connection;

FIG. 4 is a diagram of a GDMO configuration for a soft PVC connection according to the present invention;

FIG. 5 is a diagram of an overall Managed Object (MO) configuration shaped into a GDMO configuration as in FIG. 4 for a soft PVC connection of an embodiment of the present invention,

FIG. 6 is a flow diagram of an initializing process by an agent for a soft PVC connection according to an embodiment of the present invention;

FIG. 7 is a flow diagram of a subscriber information setup process by an agent for a soft PVC connection according to an embodiment of the present invention;

FIG. 8 is a flow diagram of a failure occurrence process of a soft PVC connection according to an embodiment of the present invention; and

FIG. 9 is a flow diagram of a performance management process of a soft PVC connection according to an embodiment of the present invention.

### DETAILED DESCRIPTION OF THE INVENTION

The following is a discussion of TMN related terms to assist in understanding the present invention prior to describing exemplary embodiments of the present invention.

Manager and Agent

A manager and a agent are used as a pair. The manager asks information while the agent provides information. In the event a center manager asks a remote manager an alarm state of equipment, the center serves as a manager while the remote serves as an agent.

It is recommended that the manager and the agent in the TMN are laid on the CMIP (will be described below). Accordingly, the manager and the agent can be applications on the CMIP. In view of a platform, the manager is composed of a work station and equipment thereof serves as the agent.

CMIP

A Common Management Information Protocol (hereinafter, referred to as “CMIP”), a protocol name, is a protocol developed to give and take information. The CMIP exists on the uppermost position of an OSI protocol stack in the TMN. The CMIP performs a simple task. For example, if one equipment is positioned at a remote place and a person managing it exists there, a manager in a center will call the person to ask an alarm state when desiring to know the state of the remote equipment. The managing person will notify the center if any alarm has been generated. The CMIP is a protocol devised to enable a machine to understand such a situation and operates in a fashion where the equipment asks the alarm state and receives the result accordingly. This is referred to as an M-GET request and response. The M-GET request asks an alarm state while the M-GET response notifies the result. The GET asks a state and the SET changes the setup for the equipment. In addition, there are ACTION, NOTIFICATION, CREATE (managed object creation), DELETE (managed object deletion), and the like.

Guidelines for the Definition of Managed Object (GDMO)

GDMO is a language describing the type of an MO (will be described below). It is a kind such as classes of C++ and has a concept of inheritance. The standard of MO has an upper standard including GDMO and its entity is described by ASN. 1.

Management Information Base (MIB)

MIB is a database for information needed for management. It does not use a database system such as Oracle but includes information needed for management in the form of a database. The MIB is a collection of MO entities.

Managed Object (MO)

MO is, by way of example, alarm information of equipment and includes everything that can be reviewed on the equipment and be provided. To give and take the MO, a CMIP protocol is used and a frame of its class is described using GDMO and ASN.1. Accordingly, when it is said that MO is being used, it means the use of the CMIP, GDMO and ASN.1.

Comparison of SNMP and CMIP

SNMP is a management protocol playing the same role as that of CMIP and is a protocol suggested for use on a TCP/IP basis by the U.S. Department of Defense and by network equipment makers. As will be understood from its name, Simple Network Management Protocol, the protocol initially pursued very simple forms (having three operations of Get, Set, and Trap) in comparison to the CMIP developed to be applied to all network environments in common. The CMIP has an event-driven scheme while the SNMP has a manager-polling scheme. The SNMP has developed into a trap-driven-polling scheme to reduce network load.

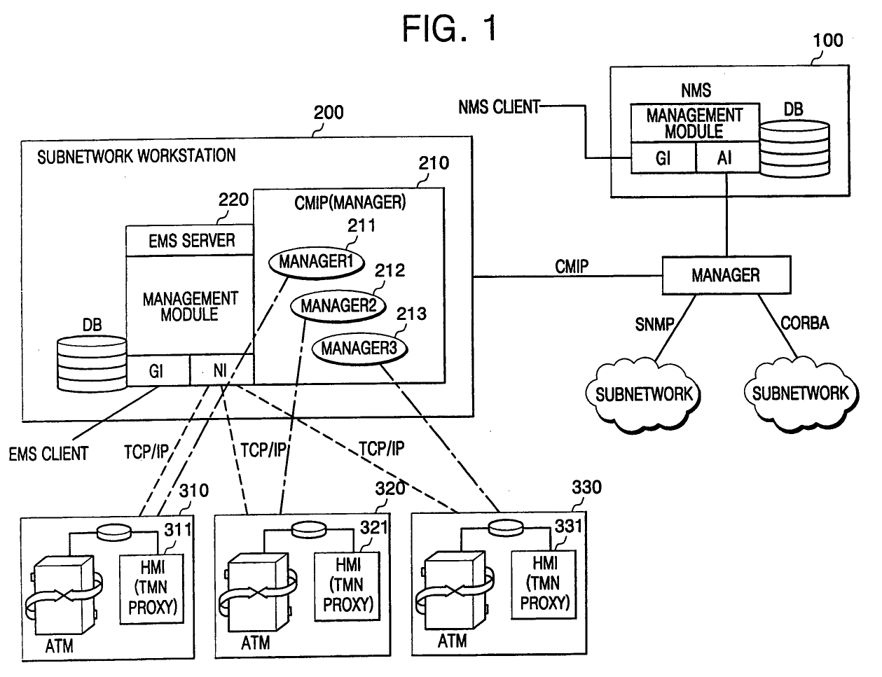

FIG. 1 is an overall network configuration diagram for explaining a role of an agent managing a soft PVC according to an embodiment of the present invention.

Referring to Fig. 1, the network includes a Network Management System (NMS) 100 which is an integrated network management operating system managed by a communication service operator, a subnetwork workstation 200 including an agent for monitoring the state of a system in a local network and for operating the system, and network elements (NEs) 310, 320, 330, . . . , each network element including an ATM switch and an HMI 311, 321 or 331 with a TMN proxy.

The NMS 100 includes a Management Function (MF) module for managing the overall NMS except for an interface module, a Graphic User Interface (hereinafter, referred to as a “GUI”) interface (GI) for interfacing with an NMS client terminal that issues an instruction to the NMS 100 and processes information, an Agent Interface (AI) for interfacing with an agent, and a DataBase (DB) for storing physical and logical information of the network.

Furthermore, the workstation 200 in each local network (i.e., subnetwork) can include an agent (that is, a CMIP agent in the present invention) 210, and an EMS server 220.

The EMS server 220 is not included in the workstation 200 but is configured as separate equipment. The EMS server 220 includes a managing module for managing the overall EMS except for the interface module, a GUI Interface (GI) for interfacing with an EMS client terminal, an NE Interface (NI) providing an interface with a network element, and a DataBase (DB) for storing physical and logical information of the network.

The CMIP agent 210 includes agents 211, 212, and 213 connected to their respective network elements 310, 320, and 330 to process instructions received from the NMS 100.

HMIs (TMN proxies) 311, 321, and 331 play a proxy role between the ATM switch and their respective agents 211, 212, and 213. Each of the HMIs translates an instruction and a parameter received from an agent so that they are processed by the actual ATM switch, delivers the translated instruction and parameter to each instruction related daemon block within the switch, and delivers back the result from the daemon block to the agent. Upon a failure, a status and performance related message is generated in each of MOs of the relevant network elements 310, 320 and 330, and the HMI delivers the message to the agent.

Since the agents cannot directly obtain information for the MOs of the ATM switches, the agents are allowed to acquire the information through the HMIs (TMN proxies) 311, 321 and 331, and the HMIs (TMN proxies) 311, 321 and 331 collect respective managed object information via the IPC.

The above-stated configuration of an embodiment of the present invention has its greatest distinction from that of the prior art in that the agent function that was included in the NEs 310, 320 and 330 has been divided into a separate function. The present invention has been described by way of example in connection with the workstation including the agent function.

The objects managed by the agents are as follows:
Configuration management: shape addition/deletion, port resource allocation/modification/deletion, SVC/PVC range setup/modification/release, subscriber information creation/modification/deletion, and the like.
Failure management and state management: a rack, a shelf, a slot, a board, a link, a fan, a filter, a node, a connection, and the like.
Performance management: atmTrafficLoad, upcNpc, and the like for a relevant port or connection point upon soft PVC connection.
Connection management: soft PVC connection creation/deletion, connection re-setup (automatic re-setup, connection based retrial, block based collective resume), path retrieval, and the like.

The agent is internally based upon a network management standard GDMO (M.3100, I.751,X.721, and the like) using data obtained through different upper/lower interfaces, and can use a partially changed existing GDMO or a newly created GDMO in the present invention. This will be described in detail below through a GDMO with reference to the accompanying drawings.

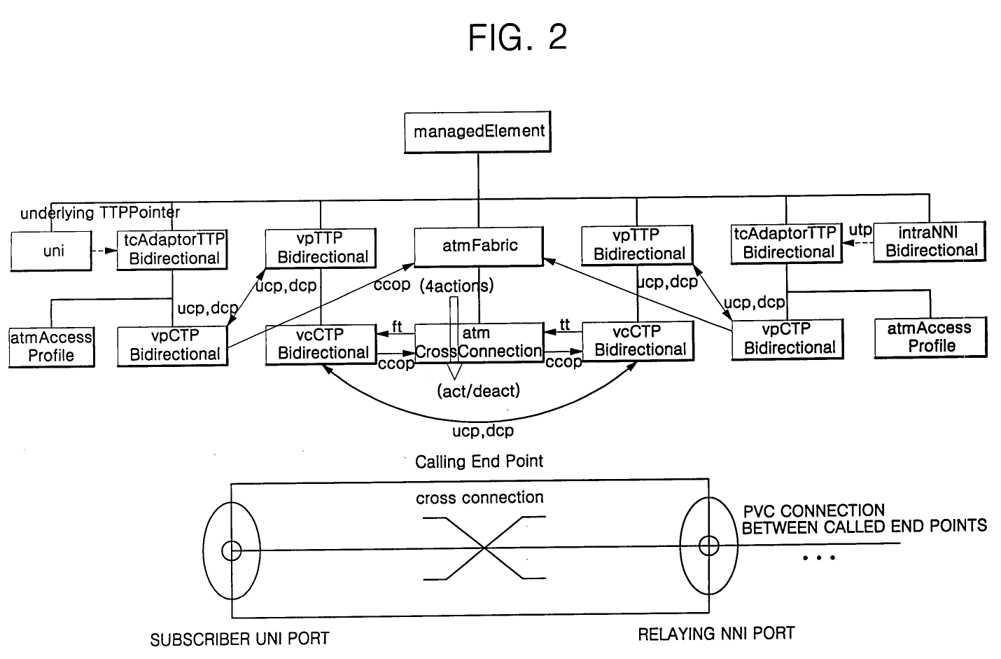

First, a GDMO configuration for a PVC connection will be described with reference to FIG. 2.

To establish a PVC connection according to a network management standard, atmFabric is subject to an M-ACTION for connection, creates each connection terminal point (CTP) MO instance and an atmCrossConnection MO instance according to a system connection state, and points a connection relation between them. They are all MO instances for a subscriber UNI port connection point and a relaying NNI port connection point.

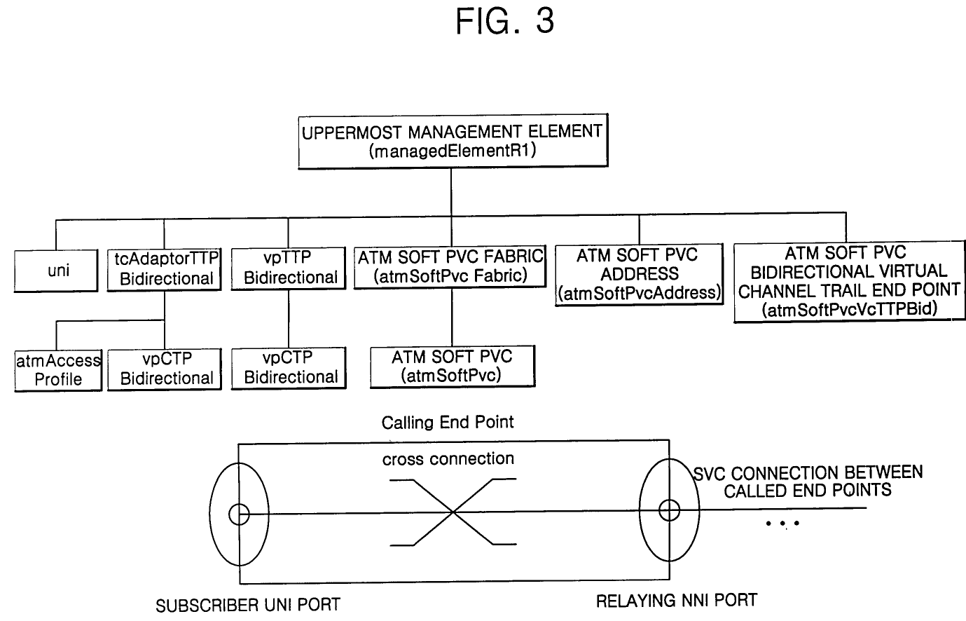

FIG. 3 is a diagram of a GDMO configuration for a soft PVC connection.

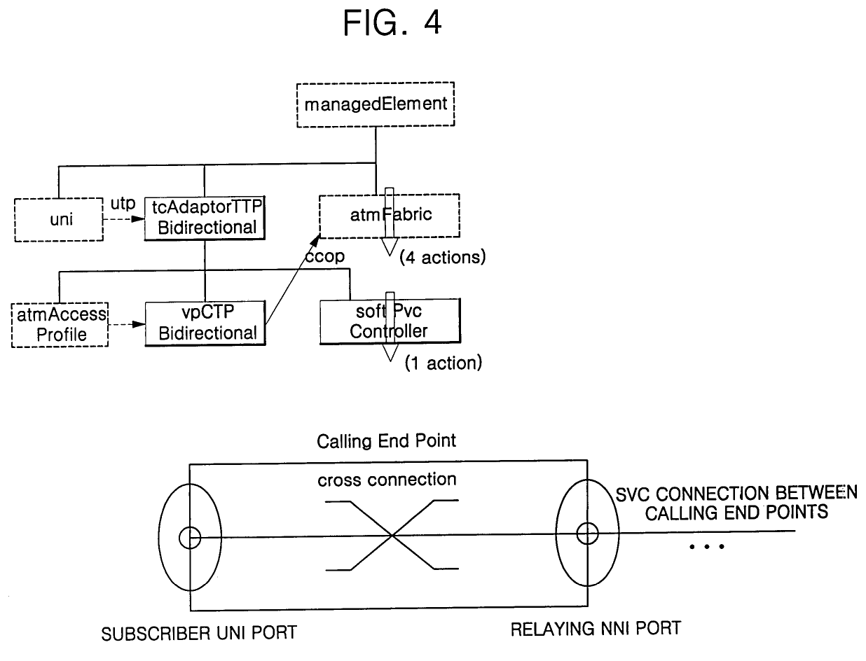

Referring to FIG. 3, after instructions (M-Create) to create a subscriber address (atmSoftPvcAddress), a VP port (vpCTPBidirectional, vpTTPBidirectional), a calling-side ctp (veCTPBidirectional), and a SVC trail end point (atmSoftPvcTTPBidirectional) are issued, respectively and, to establish a soft PVC connection, atmSoftPvcFabric is subject to an M-ACTION for connection to create connection information (atmSoftPvc) and to point each connection relation. The subscriber UNI port connection point, the relay-side SVC end point, the subscriber address, and the connection information exist as respective MO instances. Unlike the foregoing, the GDMO configuration for the soft PVC connection according to an embodiment of the present invention is as shown in FIG. 4.

Referring to FIG. 4, to establish a new soft PVC connection, the atmFabric is subject to an M-ACTION for a connection to create each Connection Terminal Point (CTP) MO instance in conformity with a system connection state, wherein those that are related are pointing one another. There is only an MO instance for the subscriber UNI port connection point.

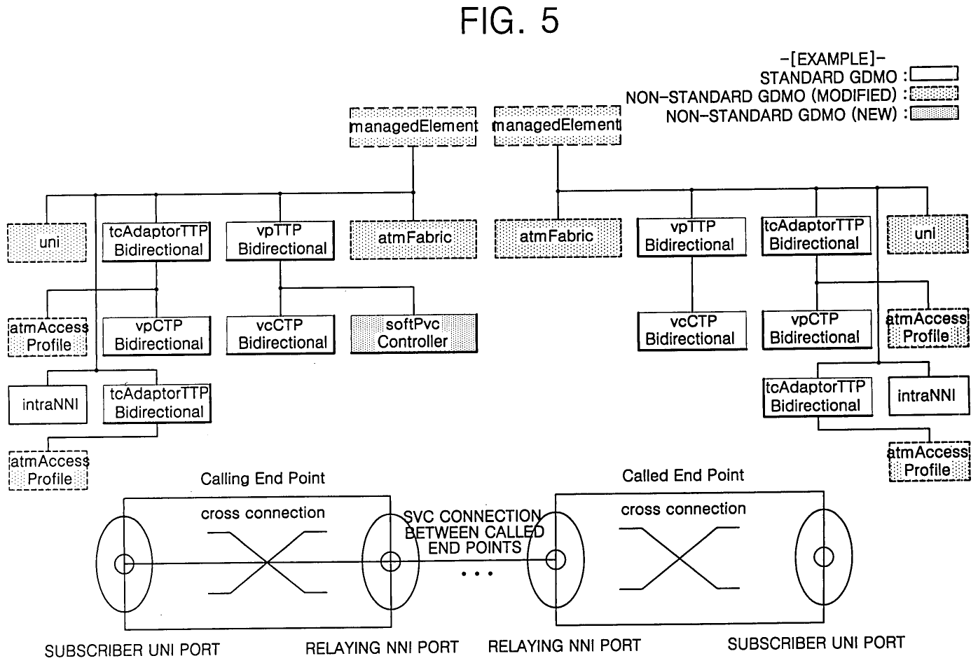

FIG. 5 is a diagram of an overall MO configuration between a calling side and a called side for a soft PVC connection of an embodiment of the present invention, which is shaped into the GDMO configuration as shown in FIG. 4.

First, a standard GDMO instance will be described with reference to FIG. 5.

The MOs are shaped into:
a managedElement MO instance regarding an ATM switch,
a tcAdptorTTPBidirectional MO instance regarding a port,
a uni MO instance regarding a subscriber UNI port,
an intra MO instance regarding a relaying NNI port,
an atmAccessprofile MO instance regarding port's logical information (bandwidth, VPI value, VCI value, and the like),
an atmFabric MO instance for issuing a logical connection setup instruction,
a vpCTPBidirectional MO instance regarding a connection end point upon VP connection or a VP connection end point through that a VC will pass upon VC connection,
a vcCTPBidirectional MO instance regarding a connection end point upon VC connection, and
a vpTTPBidirectional MO instance regarding a VP connection end point though which the VC will pass upon VC connection.

The MOs are shaped into modified GDMO instances, such as:
an MO instance regarding the managedElement created based on a switch's node prefix (having prefix related office code and a trunk code) for the soft PVC connection,
an MO instance regarding uni modified to include information on subscriber addresses (sn: subscriber number),
an MO instance regarding atmAccessProfile in which PVC/SVC resources are modified in the existing standard information to differentiate PVC/SVC resources from each other, and
an MO instance regarding an atmFabric that is modified by selecting a representative MO for executing a soft PVC connection related instruction separately from the PVC connection and by adding a soft PVC related M-ACTION.

The MOs are shaped into newly created GDMO instances, such as: an MO instance regarding SoftPvcController for adding information for a called-side subscriber address, a called-side VPI/VCI connection retry number, and the like to allow a calling side to manage called-side information.

The agent builds a Management Information Base (hereinafter, referred to as an “MIB”) in which all information is translated into MO instances in conformity with such a GDMO structure.

The agent receives CMIP instructions (M-CREATE, M-GET, M-SET, and M-ACTION) from the upper manager for operation, analyzes the instructions, and at the same time determines the content to be delivered to an actual system through pre-and post-processing defined on each MO basis. If an instruction is issued to the system via the TMN proxy, the performing result and information is again delivered to the agent via the TMN proxy. The agent analyzes the received message, builds the MIB shape again, and delivers the result to the manager. Furthermore, failure, state, performance, and data are periodically delivered from the system to the manager.

A process performed by the agent (i.e., CMIP agent) for network management after the MIB is completed through shaping the MO as described above is described in detail below.

The agent provides the following soft PVC functions to the soft PVC.

If the agent is initially operated, the agent provides an initializing process, a soft PVC subscriber information setup process, a soft PVC connection creation and deletion, connection path inquiry, failure handling, performance management, connection re-setup, and archiving functions.

The agent must first perform the initializing process to fetch information on all MOs in the current system.

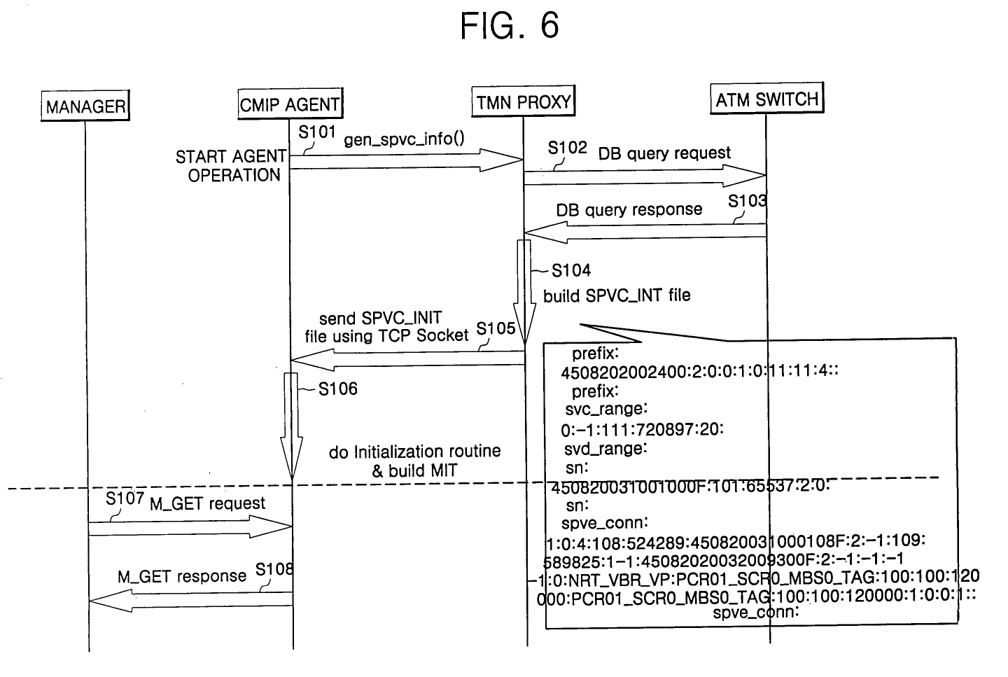

The initializing process by the agent for the soft PVC connection according to an embodiment of the present invention is described below with reference to FIG. 6.

The CMIP agent invokes an initialization instruction (gen_spvc_init()) function upon initial operation and issues the instruction to the TMN proxy (S101), and the TMN proxy retrieves a system database (S102) and receives the result data (S103).

The TMN proxy builds an initialization file (SPVC_INIT) using the acquired data in conformity with the determined format (S104).

The initialization file can be structured as shown in Table 1:

TABLE 1
prefix:
PFX:NPI:TON:AFI:CLTY:RTE:MIN:MAX:SIG_TYPE:NAME:
prefix:
svc_range:
ACC:AMC:TCID:SVC_RANGE:MAX_SVC_VPI
svc_range:
sn:
SN:TCID:NPI:AFI
sn:
spvc_conn:
VPFLAG:SIG_TYPE:ACT_FLAG:OTCID:OSN:OVPI:OVCI:TSN:TVPI:TVCI:IN_{—}
OUT_FLAG:
CONN_TYPE:FCONB:FTR1:FTR2:FTR3:FCDVT:BCOMB:BTR1:BTR2:BTR3:BCDVT:
SNAME:
spvc_conn:

Next, the TMN proxy sends the initialization file to the CMIP agent via the socket (S105), and the CMIP agent makes the content of the initialization file into a GDMO instance (S106). If the manager requests information (S107), the CMP agent sends the relevant information to the manager (S108).

Parameters of the initialization file in Table 1 are defined as follows.

Table 2 relates to prefix (ATM switch address information) initialization configuration parameters.

TABLE 2

| Field | Description |
|---|---|
| PFX | ATM switch address (Prefix) |
| NPI | Numbering system (Numbering Plan Indication) |
| TON | Type of Number |
| AFI | Numbering format (Authority and format identification) |
| CLTY | Call type |
| RTE | Route number |
| MIN | Minimum address length |
| MAX | Maximum address length |
| SIG_TYPE | Signal type |
| NAME | Number name |

Table 3 relates to svc_range (SVC range information) initialization configuration parameters.

TABLE 3

| Field | Description |
|---|---|
| ACC | High-speed management process number. 1 at |
| | low speed |
| AMC | Low-speed management process number. 1 at |
| | high speed |
| TCID | Port ID. (e.g., rackId * 100000 + shelfId * 10000 + |
| | slotId * 100 + linkNo) |
| SVC_RANGE | vpi range upon SVC path setup |
| MAX_SVC_VPI | Maximum SVC vpi range |

Table 4 relates to subscriber number (sn) initialization configuration parameters.

TABLE 4

| Field | Description |
|---|---|
| SN | Subscriber Number |
| TCID | Port ID. (e.g., rackId * 100000 + shelfId * 10000 + slotId * 100 + |
| | linkNo) |
| NPI | Numbering system (Numbering Plan Indication) |
| AFI | Number format (Authority and format identification) |

Table 5 represents spvc_conn (SPVC connection information).

TABLE 5

| Field | Description |
|---|---|
| VPFLAG | VP/VC connection flag. (VP: 1, VC: 0) |
| SIG_TYPE | Signal Type |
| ACT_FLAG | Connection status flag (Active Status) |
| OTCID | Calling-side port ID. |
| | (e.g., rackId * 100000 + shelfId * 10000 + slotId * |
| | 100 + linkNo) |
| OSN | Calling-side subscriber address |
| OVPI | Calling-side VPI |
| OVCI | Calling-side VCI (1 at VP connection) |
| TSN | Called-side subscriber address |
| TVPI | Called-side VPI |
| TVCI | Called-side VCI (1 at VP connection) |
| IN_OUT_FLAG | Direction of a Soft-PVC connection |
| CONN_TYPE | Connection type |
| FCOMB | Forward traffic combination |
| FTR1 | First value of forward traffic |
| FTR2 | Second value of forward traffic |
| FTR3 | Third value of forward traffic |
| FCDVT | Forward CDVT |
| BCOMB | Reverse traffic combination |
| BTR1 | First value of reverse traffic |
| BTR2 | Second value of reverse traffic |
| BTR3 | Third value of reverse traffic |
| BCDVT | Reverse CDVT |
| SNAME | Connection name |

If the initialization is completed, a process of distributing and managing a port resource and creating a subscriber number is performed to establish a soft PVC connection.

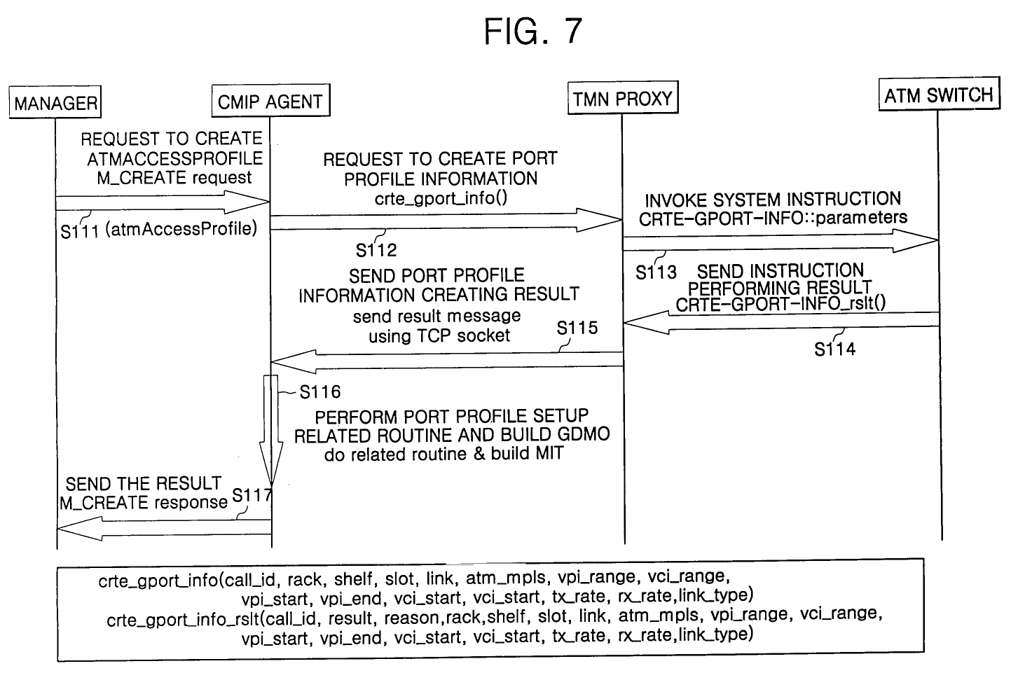

FIG. 7 is a flow diagram of a subscriber information setup process by an agent for a soft PVC connection according to an embodiment of the present invention.

A subscriber information setup process includes port profile setup, link type setup, and subscriber number creating processes.

FIG. 7 is a diagram of the port profile setup in the subscriber information setup process. Referring to FIG. 7, the CMIP agent receives an M-CREATE instruction for atmAccessProfile from the manager (S111) and invokes a relevant function (crte_gport_info()) of the TMN proxy (S112). The TMN proxy delivers a relevant instruction (CRTE_GPORT_INFO: parameter executing instruction) to the ATM switch (S113), and receives the instruction performing result (crte_gport_info_rslt()) from the ATM switch (S114).

The TMN proxy delivers the result to which relevant port information has been reflected, to the CMIP agent via a TCP socket (S115). The CIMP agent creates an atmAccessProfile MO instance based upon the data received from the TMN proxy (S116), and reports the result to the manager (S117).

The link type process in the subscriber information setup process can be summarized as follows:

In the case of a subscriber purpose, the agent receives an instruction to create UNI from the manager. In the case of a relaying link purpose, the agent receives an instruction to create a relaying NNI (NNI link) from the manager. Then, the agent delivers the instruction to the ATM switch via the TMN proxy, receives the processing result, creates an MO instance if the link type is the same as the system link type, and reports the result to the manager. After creating the MO instance, the agent designates an underlyingTTPPointer to the relevant link (tcAdaptorTTPBidirectional).

The subscriber number creating process is as follows. The agent receives a subscriber number creating instruction (M-SET) from the manager to invoke a relevant function of the TMN proxy. The agent receives the processing result via the socket, sets up a subscriber number to the UNI MO instance, and reports the result to the manager. However, address information (prefix) of the switch node is managed in an agent's ATM MO instance, wherein the address information is divided into international, national, office, trunk code, and the like in the information set up by the switch (internal prefix and external prefix). The manager inquiring this information allocates and issues a SN number to the agent.

Since the connection creating and deletion processes progress in the same fashion as those in the initializing process and the subscriber information setup process, they have not been included in the drawing figures.

However, since the present invention has a difference in a function as compared to the prior art, its characteristics are discussed in detail below.

The connection service implemented by the agent is commonly implemented by a method suggested in the standard. That is, the agent receives a CMIP instruction from the upper manager, reflects relevant information to the switch system through a switch instruction, and creates/deletes a connection point CTP (vpCTPBidirectional and vcCTPBidirectional) that is representative of a connection point and a trail (vpTTPBidirectional) MO instance to match with switch information.

The present invention has a different structure from that of the conventional PVC or soft PVC. That is, the present invention does not create the MOs for the intermediate SVC path upon creating the soft PVC connection. Accordingly, the present invention has an advantage in that the number of MOs is reduced.

TABLE 6

| | Conventional | Conventional soft | |
|---|---|---|---|
| | PVC | PVC | Inventive soft PVC |
| VP connection | 6 | 6 | 3 |
| VC connection | 14 | 12 | 7 |

Referring to Table 6, since six PVCs (vpCTPBidirectional*4 and atmCrossConnection*2) are created, six conventional soft PVCs (vpCTPBidirectional*2, atmSoftPvc*2, and atmSoftPvcAddress*2) are created, three soft PVC of the present invention (vpCTPBidirectional*2 and softPvcController*1) are created per one VP connection, it is possible to reduce the number of the MOs to almost half that of the prior art MOs.

Since fourteen PVCs (vpCTPBidirectional*4, vpTTPBidirectional*4, vcCTPBidirectional*4, and atmCrossConnection*2 are created, twelve conventional soft PVCs (vpCTPBidirectional*2, vpTTPBidirectional*2, vcCTPBidirectional*2, vpTTPBidirectional*2, atmSoftPvc*2, and atmSoftPvcAddress*2) are created, and seven inventive soft PVCs (vpCTPBidirectional*2, vpTTPBidirectional*2, vcCTPBidirectional*2, and softPvcController* 1) are created per one VC connection, it is possible to reduce the number of MOs to almost half that of the prior art MOs.

That is, for the VP connection in the soft PVC, an atmCrossConnection MP instance is not required but only one ctp per a switch is required. Since it exists only in a softPvcControllersms calling side, three MO instances will be created.

For the VC connection, since only a portion for the VP port resource (vpCTPBidirectional and vpTTPBidirectional) is added, four connections are added to the number of VP connections.

Accordingly, the use of the memory upon initializing and operating the agent can be reduced, operating speed is improved and program loading time is shortened.

Since ctp at a called end point is deleted when a failure occurs, the MO can be further reduced.

A process upon the occurrence of a failure during a soft PVC connection is discussed below with reference to the drawings.

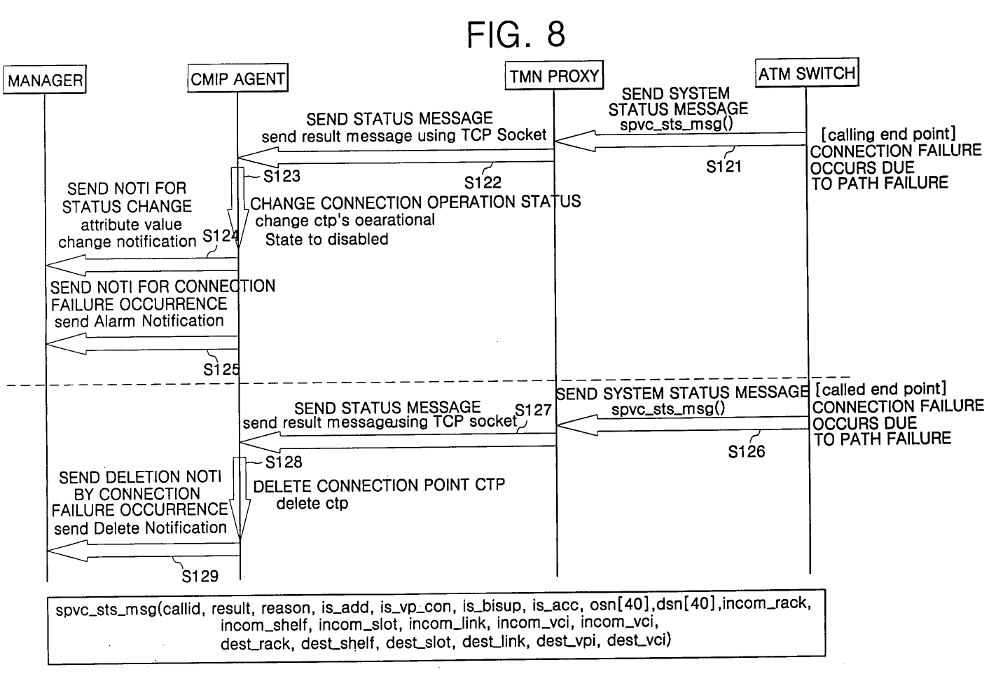

FIG. 8 is a flow diagram of a failure occurrence process of soft PVC connection according to an embodiment of the present invention.

If a failure occurs in the managed system link, a soft PVC connection failure can occur. In a conventional PVC, if a link failure is released, a connection failure was automatically released and accordingly the connection failure was not processed separately.

In a soft PVC connection, as shown in FIG. 8, if a connection failure due to an SVC path failure occurs, the ATM switch sends a system status message (spvc_sts_msg) to the TMN proxy (S121). The TMN proxy delivers the result to which the relevant status message information has been reflected, to the CMIP agent via the TCP socket (S122).

The CMIP agent analyzes the message and, in the case of the calling end point, changes the operation state of the soft PVC connection point in the relevant link (CTP MO: vpCTPBidirectional MO in the case of the VP connection and a vcCTPBidirectional MO in the case of the VC connection) into disabled (S123).

Next, the CMIP agent sends notification regarding the state change and failure occurrence to the manager (S124 and S125).

Hereafter, if the failure is released, the ATM switch sends a system state message (spvc_sts_msg) to the TMN proxy, and the TMN proxy delivers the result to which the relevant state message information has been reflected, to the CMIP agent via the TCP socket.

The CMIP agent analyzes the message and changes the operations status of the soft PVC connection point in the relevant link (CTP MO: vpCTPBidirectional MO in the case of the VP connection and vcCTPBidirectional MO in the case of the VC connection) in the case of the calling end point into enabled.

Then, the CMIP agent sends a notification regarding the state change and failure release to the manager.

When a failure occurs in the called end point, the ATM switch determines that a signal in the SVC period has been interrupted and sends a system state message (spvc_sts_msg) to the TMN proxy (S126). The TMN proxy delivers the result to which the relevant state message information has been reflected, to the CMIP agent via the TCP socket (S127).

The CMIP agent deletes a connection point (ctp) MO instance to a link where the failure has occurred (S128), and notifies the manager that the connection point MO instance has been deleted (S129).

If the failure is released, the CMIP agent creates the relevant soft PVC connection point MO.

A performance management process in a soft PVC connection is described below with the accompanying drawings.

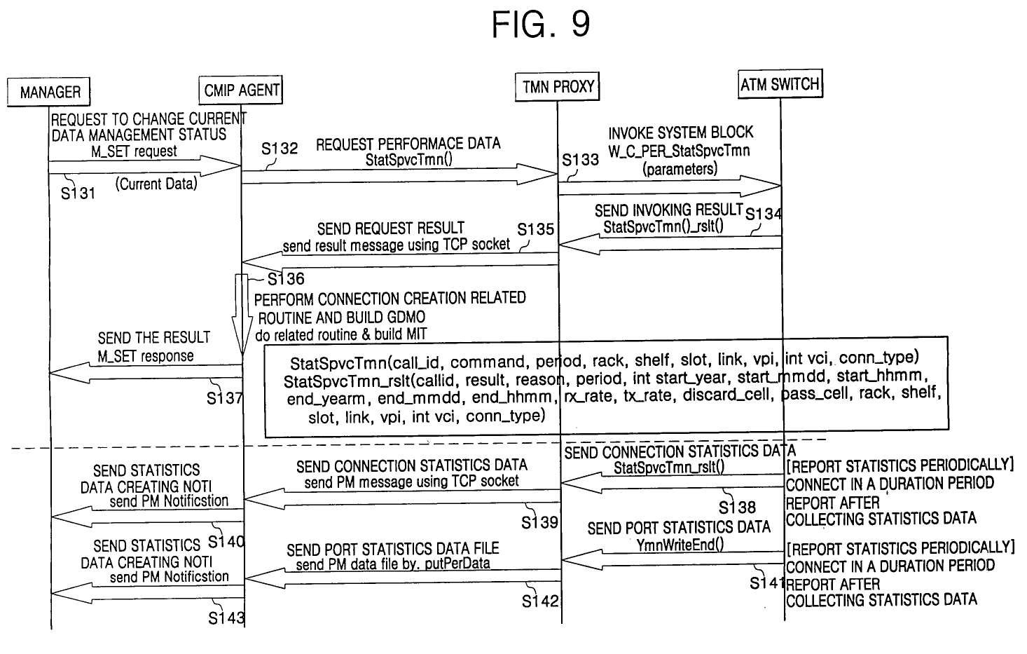

FIG. 9 is a flow diagram of a performance management process of a soft PVC connection according to an embodiment of the present invention.

The traffic state for connection is checked and an actual ATM cell is transferred to analyze statistics data periodically before the subscriber is accepted. Such performance management has a port and a connection point as objects.

In the performance management process, as shown in FIG. 9, the CMIP agent receives an M-SET request currentData for a desired link or connection from the manager (S131), and invokes a performance data request function (StatSpvcTmno)to the TMN proxy (S132).

The TMN proxy invokes a system block (W_C_PER_StatSpvcTmn) to the system (ATM switch) to request activation of performance data (S133), and the ATM switch delivers the result (StatSpvcTmn_rslt()) to the TMN proxy (S134).

The TMN proxy delivers the relevant result message to the CMIP agent via the TCP socket (S135). The CMIP agent configures the performance management related content into a GDMO instance (S136), and sends the relevant information to the manager (S137).

Then, the CMIP agent receives connection statistics data from the ATM switch for a predetermined period (S138 and S139) and reports it to the manager (S140).

Furthermore, the CMIP agent receives port statistics data from the ATM switch for a predetermined period (S141 and S142) and reports it to the manager (S143).

For the soft PVC connection, a performance data report is maintained in a calling end point's connection point even after a SVC path is switched due to a failure.

Hereinafter, detailed descriptions on a connection path inquiry, a connection re-setup, and an archiving function among the functions provided by the agent for the soft PVC connection have been omitted because they are similar to the above-described initializing process and subscriber information setup process.

Since the connection re-setup and connection path inquiry progresses are the same as those of the initializing process and the subscriber information setup process, an illustration thereof and description thereof has been omitted.

However, the differences in function in comparison with the prior art is discussed below.

First, in the case of the connection re-setup, when a failure occurs on an intermediate path in the system, the soft PVC connection will be automatically switched to another available SVC path. The number and interval of re-setup attempts can be set up upon system initialization.

If the number of automatic re-setups is exceeded when a relevant connection failure occurs, it is managed as a fail state even after failure release on the intermediate SVC path occurs later, wherein the operation state of the relevant connection point is managed as disabled. In this case, the manager provides ACTION to the softPvcController so that a re-setup instruction is issued to one connection (connection based retry) or a number of connections (collective resume) where a current failure exists manually. In the case of the re-setup connection, the operation state of the connection point is managed as enabled.

Subsequently, the connection path inquiry is a function of inquiring a connection path from each end point to the SVC connection point or from the SVC connection point to the end point. The connection point of the SVC path on the GDMO is not managed.

Although embodiments of the present invention have been described in detail, it is to be understood by those skilled in the art to which the present invention pertains that various modifications and variations can be made to the present invention without departing from the technical spirit and scope of the present invention as defined by the appended claims.

As described above, with the common management information protocol agent for the soft Permanent Virtual Circuit management in the asynchronous transfer mode switch according to the present invention, it is possible to reduce the burden on the efficiency of the resource, the continuity of the service, and the user of a service upon accepting subscribers in comparison to the PVC connection. More particularly, it is possible to significantly reduce the number of MOs as compared to an existing soft PVC.

Furthermore, since handling the MOs is performed in a state where the number of MOs is reduced, tasks to be handled by the agent are reduced. Since the number of instructions performed by the manager is reduced and some of the instructions are performed by the agent, the manager's operating burden is reduced.

It is possible to manage called-side management information without separate instructions from the manager. For connection creation/deletion management, the manager issues only an M-Action to the calling side and the called side is processed as a status message.

In addition, since the number of MOs is reduced, network management program capacity of the agent is significantly saved, thereby reducing management costs.

1. A network management system for a soft Permanent Virtual Circuit(PVC), the system comprising:
a plurality of managed systems;
an upper manager adapted to fetch information for Managed Objects (MOs) from the plurality of managed systems and to issue an instruction to the MOs; and
a workstation, including respective agents connected to the plurality of managed systems in a one-to-one manner, adapted to deliver the instruction from the upper manager to the plurality of managed systems on behalf of the upper manager and to deliver the MO information from the plurality of managed systems to the upper manager, the workstation managing the respective agents in an integrated manner.

2. The network management system according to claim 1, wherein a protocol between the upper manager and the agent comprises a Common Management Information Protocol (CMIP).

3. The network management system according to claim 1, wherein the agents are configured separately from the plurality of managed systems and are incorporated into the workstation managing the respective agents in the integrated manner.

4. The network management system according to claim 1, wherein the agents are adapted to perform processing on a Common Management Information Protocol (CMIP) related instruction issued from the manager, to deliver the instruction to a network management proxy in the plurality of managed systems, and to reflect the instruction processing result and state from the plurality of managed systems to the MO to report to the upper manager.

5. The network management system according to claim 1, wherein an object managed by an agent comprises:
configuration management including at least one of shape addition and deletion, port resource allocation, modification and deletion, SVC and PVC range setup, modification and release, and subscriber information creation, modification and deletion;
failure management and state management including at least one of rack, shelf, slot, board, link, fan, filter, node, and connection;
performance management including atmTrafficLoad and upcNpc for a relevant port or connection point upon a soft PVC connection; and
connection management including at least one of soft PVC connection creation and deletion, connection re-setup including at least one of automatic re-setup and connection based retrial and block based collective resume, and path retrieval.

6. The network management system according to claim 5, wherein the MOs for building a Management Information Base (MIB) for the objects managed by the agent comprise:
a standard MO shaped into at least one of a managedElement MO (Managed Object) regarding an ATM switch, a uni MO regarding a subscriber UNI port, a tcAdptorTTPBidirectional MO regarding a port, an intraNNI MO regarding a relaying NNI port, an atmAccessProfile MO regarding port's logical information (bandwidth, VPI value, VCI value, and the like), an atmFabric MO for issuing a logical connection setup instruction, a vpCTPBidirectional MO regarding VP connection end point through which a connection end point upon VP connection or VC upon VC connection will pass, a vcCTPBidirectional MO regarding the connection end point upon the VC connection, and a vpTTPBidirectional MO regarding the VP connection end point through which the VC will pass upon the VC connection;
a modification MO shaped into at least one of an MO regarding managedElement created based on a node prefix (having added prefix related office code and trunk code) of a switch for a soft PVC connection, an MO regarding uni modified to include information on a subscriber address (sn: subscriber number), an MO regarding atmAccessProfile in which PVC/SVC resources in existing standard information are modified to differentiate PVC/SVC resources from each other, and an MO regarding an atmFabric that is modified by selecting a representative MO for executing a soft PVC connection related instruction separately from the PVC connection and by adding a soft PVC related M-ACTION; and
a new MO shaped into at least one of an MO regarding SoftPvcController for adding information for a called-side subscriber address, a called-side VPI/VCI connection retry number, and the like to allow a calling side to manage called-side information.

7. The network management system according to claim 6, wherein the agent builds the MIB by shaping a needed MO with a Common Management Information Service Element (CMISE).

8. A network management method for a soft Permanent Virtual Circuit (PVC), the method comprising:
building a Management Information Base (MIB) by shaping Managed Objects (MOs) for soft PVC network management according to an MO standard;
performing an initialization operation on an agent through the shaped MIB;
distributing port resources and setting up subscriber information to establish the soft PVC connection after the agent initialization;
creating MOs for connection points to obtain information from a managed system and to deliver an instruction; and
selecting and performing at least one of connection path inquiry, failure management, performance management, connection re-setup, and an operation for unnecessary MOs according to an operator's need with respect to the MOs created by the connection creating step.

9. The network management method according to claim 8, wherein shaping the MO information in building the MIB comprises:
defining standard MOs including at least one of an ATM switch MO, a subscriber UNI port MO, a port MO, a relaying NNI port MO, a port's logical information MO, a logical connection setup instruction MO, a VP connection end point or VC-passing VP connection end point MO, a VC connection end point MO, and a VC-passing VP connection end point MO upon VC connection as a reference;
modifying and using the ATM switch MO, the subscriber UNI port MO, the port's logical information MO, and the logical connection setup instruction MO that can be modified from among the standard MOs; and
newly creating a SoftPvcController MO for adding information for at least one of a called-side subscriber address, and a called-side VPI/VCI connection retry number to allow a calling side to manage called-side information.

10. The network management method according to claim 8, wherein performing initialization upon initially operating the agent comprises:
invoking, by the agent, an initialization instruction function to deliver the invoked function to a network management proxy in the managed system;
retrieving, by the network management proxy, a system database to query initialization information;
acquiring initialization information by the agent;
creating, by the network management proxy, an initialization file according to a predetermined format using the acquired data;
transmitting the initialization file to the agent by the network management proxy; and
shaping, by the agent, contents of the initialization file, delivered after performing the initialization routine, into the managed object to build the MIB.

11. The network management method according to claim 10, wherein the initialization file created by the network management proxy comprises:
a prefix (ATM switch address information) initialization configuration parameter;
a svc_range (SVC range information) initialization configuration parameter;
a sn (subscriber number) initialization configuration parameter; and
a spvc_conn (SPVC connection information) initialization configuration parameter.

12. The network management method according to claim 10, further comprising transmitting the relevant information to the manager by the agent in response to an information request from the manager.

13. The network management method according to claim 10, wherein setting up the subscriber information comprises:
setting up a profile for a subscriber port to distribute the respective PVC and SVC resources and set up information;
creating, by the agent receiving an instruction to create a link type from the manager, an MO to report the result to the manager when the link type is the same as the link type of the system obtained via the network management proxy; and
reporting, by the agent receiving an instruction to create a subscriber number from the manager, a subscriber number obtained via the network management proxy to the manager.

14. The network management method according to claim 13, wherein setting up the profile for the subscriber port comprises:
receiving, by the agent, an instruction to create port's logical information from the manager;
delivering, by the agent, a request signal to create port profile information to the network management proxy;
delivering a relevant instruction to the managed system by the network management proxy;
receiving an instruction performance result from the managed system;
delivering to the agent, by the network management proxy, the result to which the relevant port information has been reflected;
shaping, by the agent, the port's logical information into the managed object based on data received from the network management proxy to build the MIB; and
reporting the result to the manager.
